(19) United States
(12) Patent Application Publication
(10) Pub. No.: US 2016/0359187 A1
(43) Pub. Date: Dec. 8, 2016

(54) CELL MODULE

(71) Applicants: YUAN ZE UNIVERSITY, Taoyuan City (TW); HOMYTECH CO., LTD., Taoyuan City (TW)

(72) Inventors: CHI-YUAN LEE, Taoyuan City (TW); CHIA-HUNG CHEN, Taoyuan City (TW); CHIN-LUNG HSIEH, Taoyuan City (TW); YEN-PU HUANG, Taoyuan City (TW)

(21) Appl. No.: 14/792,681

(22) Filed: Jul. 7, 2015

(30) Foreign Application Priority Data
Jun. 5, 2015 (TW) 104118361

(51) Int. Cl. H01M 8/18; H01M 8/04; H01M 8/20

(52) U.S. Cl. CPC H01M 8/188; H01M 8/20; H01M 8/0438; H01M 8/04582; H01M 8/04552; H01M 8/0432

(57) ABSTRACT

A cell module includes an ion exchange membrane, a first electrode, a second electrode, a first current collector plate, and a second current collector plate. The first electrode and the second electrode are disposed at two sides of the ion exchange membrane, wherein a sensing element is disposed in the first electrode, and the first electrode includes an insulating frame. The first current collector plate is located at one side of the first electrode, and the second current collector plate is located at one side of the second electrode.

### BACKGROUND OF THE INVENTION

1. Field of the Invention

The instant disclosure relates to a cell module; in particular, to a cell module including a sensing element therein.

2. Description of Related Art

As the industry develops quickly, fossil energy is consumed by humans faster and faster. In addition to causing the severe shortage of fossil energy, the ecological environment becomes worse. Thus, to develop renewable energy and energy storage technology with high efficiency and low pollution to replace the fossil energy is important.

In general, the renewable energy such as ocean current power, tidal power, geothermal energy, wind power, and solar power, especially the solar power and wind power, do not pollute the environment and have abundant sources, but the solar power and wind power are liable to be affected by climate change, and cannot stably supply power. Thus, renewable energy and the large energy storage device need to cooperate together, so as to make up a complete power supply system to make sure there is a stable power supply.

Recently, the batteries such as the redox flow battery (RFB) and fuel cell are widely used, and both of them are large and high efficiency electrochemical energy storage devices. The flow battery has a cell module and two containers respectively for the positive and negative electrolytic solutions, and the positive and negative electrolytic solutions are pumped into the cell module by a pumping element. Then, via sandwiching the ion exchange membrane, the electrochemical reaction is conducted to generate the electrical energy, and the electrochemical reaction is reversible, such that the flow battery can conduct the charging and discharge process repeatedly. Therefore, when the power supply of the renewable energy exceeds the demand, via charging the flow battery, the electrical energy can be converted into chemical energy to be stored in the electrolytic solution; when the power supply of the power supply device cannot satisfy the demand, via discharging the flow battery, unstable power supply can be avoided.

It is worth to mention that, due to the flow battery or fuel cell being sealed instantly after being manufactured, when the flow battery or fuel cell conducts the electrochemical reaction, the status inside the battery cannot be known. For example, when the battery is operating, due to inside the cell module having temperature maldistribution, the agglomeration occurs to block the internal channel from conveying the electrolytic solution, so as to influence the performance of the flow battery and shorten the lifetime of the flow battery. Moreover, the electrode of the flow battery or fuel cell can have a short circuit owing to the internal liquid of the battery and other components of the battery, so as to affect the performance of the battery. For these reasons, the present inventor contributed to research and developed the cell module of the instant disclosure to overcome the abovementioned drawbacks.

### SUMMARY OF THE INVENTION

In order to overcome the abovementioned drawbacks, the instant disclosure provides a cell module which includes an ion exchange membrane, a first electrode, a second electrode, a first current collector plate, and a second current collector plate. The first electrode and the second electrode are disposed at two sides of the ion exchange membrane, wherein a sensing element is disposed in the first electrode, and the first electrode includes an insulating frame. The first current collector plate is located at one side of the first electrode, and the second current collector plate is located at one side of the second electrode.

In a preferred embodiment, the cell module is a flow battery module. The first electrode includes a center section, the center section is surrounded by the insulating frame, the center section is composed of several layers of carbon felts, and the sensing element is disposed in the carbon felts.

In another preferred embodiment, the cell module is a fuel cell module. The first electrode includes an anode diffusion layer and an anode catalyst layer, and the sensing element is disposed in the anode diffusion layer. Preferably, the anode diffusion layer is composed of several layers of carbon felts, and the sensing element is disposed in the carbon felts.

Due to the ordinary flow battery and fuel cell both having a sealed structure, we cannot know the status inside the battery when their manufacturing has been completed, and when the battery cannot normally supply the power, though we are aware the battery has been damaged, it is really an inconvenience. During the manufacturing, a sensing element is produced in the flow battery or the fuel cell of the embodiment in the instant disclosure, and the battery is then sealed, such that the status inside the battery can be obtained depending on the data measured by the sensing element.

In one embodiment of the instant disclosure, an insulating frame is produced in the flow battery or the fuel cell, so as to insulate the pipeline passing through the electrode and the center section of the electrode. In such a way, the electrode of the battery and other components of the flow battery of the instant disclosure are not liable to have a short circuit, and the problems relating to the short circuit of the battery can be improved.

In order to further appreciate the characteristics and technical contents of the present invention, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a schematic view of a flow battery module of one embodiment in the instant disclosure;

FIG. 2 shows an architecture view of a flow battery control system of the embodiment in the instant disclosure; and

FIG. 3 shows a schematic view of a fuel cell module of one embodiment in the instant disclosure.

### DETAILED DESCRIPTION OF THE PREFERRED EMBODIMENTS

Embodiments of the cell module disclosed in the instant disclosure are illustrated via specific examples as follows. The following embodiments further illustrate related technologies of the instant disclosure in detail, but the scope of the instant disclosure is not limited herein.

### First Embodiment

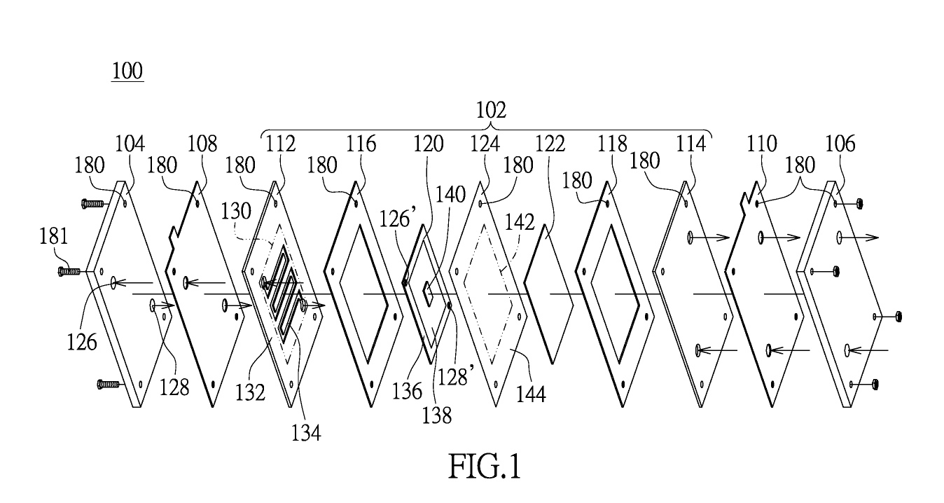

Please refer to FIG. 1. FIG. 1 shows a schematic view of a flow battery module 100 of one embodiment in the instant disclosure. The flow battery module 100 includes a battery pack 102, a first platen 104, a second platen 106, a first current collector plate 108, and a second current collector plate 110. The battery pack 102 is interposed between the first current collector plate 108 and the second current collector plate 110. The battery pack 102, the first current collector plate 108, and the second current collector plate 110 are further interposed between the first platen 104 and the second platen 106.

The battery pack 102 includes a first collector plate 112, a second collector plate 114, a first ring gasket 116, a second ring gasket 118, a first electrode 120, a second electrode 122, and an ion exchange membrane 124. In the embodiment, the first collector plate 112, the first ring gasket 116, the first electrode 120, the ion exchange membrane 124, the second electrode 122, the second ring gasket 118, and the second collector plate 114 are sequentially stacked to form into the battery pack 102. It is worth noting that, the flow battery module is not restricted to only one battery pack, that is, the flow battery module may have more than one battery pack.

Examples of the first electrode 120 and the second electrode 122 include, but are not limited to a graphite felt having porosity or a carbon felt having porosity. The first electrode 120 and the second electrode 122 are disposed at two sides of the ion exchange membrane 124. The first ring gasket 116 and the second ring gasket 118 are also disposed at two sides of the ion exchange membrane 124, and the first ring gasket 116 and the second ring gasket 118 respectively define a hollow space corresponding to the first electrode 120 and the second electrode 122, so as to receive the first electrode 120 and the second electrode 122 therein respectively. The ion exchange membrane 124, the first electrode 120 and the second electrode 122, and the first ring gasket 116 and the second ring gasket 118 are assembled into a Membrane Electrode Assembly (MEA).

In the embodiment, an example of the first electrode 120 would be an anode electrode, wherein a sensing element 140 is disposed therein. In detail, the first electrode 120 is composed of several layers of carbon felts, and the sensing element 140 may be a flexible circuit substrate interposed in the carbon felts, wherein the flexible circuit substrate may be designed for sensing the current, voltage, temperature and/or pressure inside the battery depending upon requirements. Depending on the above need, the flexible circuit substrate can be disposed with corresponding integrated circuit chips. In other words, the sensing element 140 may be a voltage sensor, a current sensor, a temperature sensor and/or a pressure sensor. However, the sensing element 140 in the instant disclosure is not restricted to the above functions and corresponding aspects, it can be modified depending upon requirements or specifications of the product. Additionally, the sensing element 140 may have a signal line electrically connecting with an external device, or further, the sensing element 140 may transmit wireless signals so that the external device can obtain measuring results. It is worth mentioning that, the flow battery module 100 of the embodiment may be disposed with one sensing element 140, but the number of the sensing elements 140 disposed in the flow battery module 100 is not limited herein. Since the ordinary flow battery and fuel cell both have sealing structure, we cannot know the status inside the battery when the manufacturing is completed. When the battery cannot normally supply the power, we are aware of the battery is damaged, and this is a real inconvenience. For that reason, the sensing element 140 is disposed in the first electrode 120 in the embodiment to overcome the above drawback. Thus, during manufacturing, the sensing element 140 is produced in the electrode of the embodiment in the instant disclosure, and the battery is then sealed, such that the status inside the battery can be obtained depending on the data measured by the sensing element 140.

As shown in FIG. 1 in the embodiment, the first collector plate 112 has a flow channel area 130, a locking area 132, and a flow channel 134, wherein the flow channel 134 is disposed in the flow channel area 130 to provide fluids (i.e., electrolytic solution) passing through there. The structure of the second collector plate 114 is identical to that of the first collector plate 112, so it does not bear repeating herein.

The first platen 104, the second platen 106, the first current collector plate 108, the second current collector plate 110, the first collector plate 112, and the second collector plate 114 both have an inlet aperture 126 and an outlet aperture 128, wherein a plurality of the outlet apertures 128 are used to drain out the fluid from the flow battery module 100, and wherein the inlet aperture 126 and the outlet aperture 128 of the first collector plate 112 both connects to the flow channel 134.

In addition, the first platen 104, the second platen 106, the first current collector plate 108, the second current collector plate 110, the first collector plate 112, the second collector plate 114, the first ring gasket 116, the first electrode 120, and the ion exchange membrane 124 both define a plurality perforations 180, and positions of the plurality of perforations 180 correspond to each other to be penetrated by a plurality of locking elements 181, so as to lock the flow battery module 100 into one piece, wherein examples of the plurality of locking elements 181 are bolts and nuts.

In the embodiment, the ion exchange membrane 124 defines an ion exchange area 142 and a border area 144, wherein the ion exchange area 142 corresponds to the first electrode 120 and the second electrode 122, and the first electrode 120 and the second electrode 122 are attached to two sides of the ion exchange area 142. The plurality of perforations 180 are disposed in the border area 144, and the plurality of locking elements 181 penetrate through the plurality of perforations 180. Therefore, the border area 144, and the first ring gasket 116 and the second ring gasket 118 can be considered as the locking area of the MEA.

In addition to the above features, in the embodiment, an insulating frame 136 is further disposed at the first electrode 120, wherein the insulating frame 136 is a non-conductive material (e.g., plastic) produced by injection molding. In detail, the insulating frame 136 surrounds the first electrode 120 having a center section 138, and the center section 138 is composed of several layers of carbon felts. Therefore, the first electrode 120 in the instant disclosure may have the center section 138 being several layers of carbon felts and have a peripheral section being an insulating material, and the insulating frame 136 may include the inlet aperture 126′ and the outlet aperture 128′, wherein the inlet aperture 126′ and the outlet aperture 128′ of the insulating frame 136 may correspond to the inlet aperture 126 and the outlet aperture 128 of the first platen 104 and the first current collector plate 108. In the instant disclosure, the first electrode 120 is manufactured with the insulating frame 136 having an advantage that a liquid line passing through the inlet aperture 126′ and the outlet aperture 128′ can be insulated via the insulating frame 136 and the center section 138 of the first electrode 120. Hence, the first electrode 120 of the flow battery in the instant disclosure is not liable to have a short circuit caused by pipelines and other components of the flow battery, and related problems owing to a short circuit can be overcome.

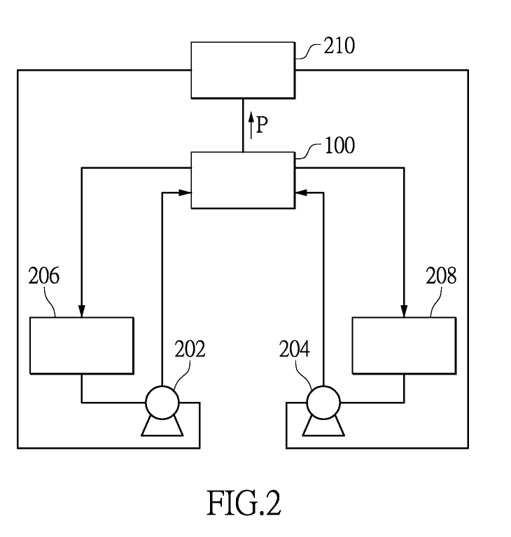

Please refer to FIG. 1 and FIG. 2. FIG. 2 shows an architecture view of a flow battery control system of the embodiment in the instant disclosure. The flow battery control system includes the flow battery module 100, a first liquid container 206, a second liquid container 208, a first pumping element 202, a second pumping element 204, and a controlling equipment 210, wherein the flow battery module 100, the first liquid container 206, the second liquid container 208, the first pumping element 202, and the second pumping element 204 are assembled to a flow battery. Examples of the flow battery include, but are not limited to a vanadium flow battery, lithium-ion flow battery, lead-acid flow battery, and other possible flow batteries.

The first liquid container 206 and the second liquid container 208 are respectively injected into the electrolytic solution including an anode and a cathode, the first liquid container 206 connects to the flow battery module and the first pumping element 202, and the second liquid container 208 connects to the flow battery module and the second pumping element 204. The flow battery module imports the electrolytic solution stored in the first liquid container 206 and the second liquid container 208 into the inside of the flow battery module via the first pumping element 202 and the second pumping element 204, so as to initiate an electrochemical reaction (redox reaction).

In an embodiment of the instant disclosure, as shown in FIG. 2, the controlling equipment 210 electrically connects to the sensing element of the flow battery module 100, the first pumping element 202, and the second pumping element 204. The controlling equipment 210 can receive a sensing signal P transmitted by the sensing element, and the controlling equipment 210 can correspondingly control the pumping element depending upon the received sensing signal P, so as to change the flow velocity of positive and negative electrolytic solutions in the flow battery module 100.

### Second Embodiment

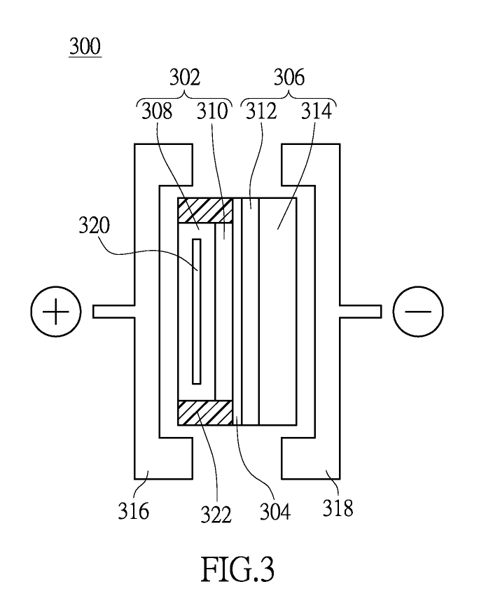

FIG. 3 shows a schematic view of a fuel cell module of one embodiment in the instant disclosure. The second embodiment and the first embodiment have the same spirit of invention, except that the sensing element and the insulating frame disposed in the electrode of the anode is applied in the fuel cell. Please refer to FIG. 3. A fuel cell module 300 includes an ion exchange membrane 304, a first electrode 302, a second electrode 306, a first current collector plate 316, and a second current collector plate 318. Wherein, the first electrode 302 includes an anode diffusion layer 308 and an anode catalyst layer 310, the second electrode 306 includes a cathode diffusion layer 314 and a cathode catalyst layer 312. A plurality of layers of the graphite felts or carbon felts are stacked to form the anode diffusion layer 308 and the cathode diffusion layer 314, the anode catalyst layer 310 and the cathode catalyst layer 312 may be a structure including platinum/carbon or platinum-ruthenium/carbon.

In the embodiment, the sensing element 320 is disposed in the anode diffusion layer 308 of the first electrode 302. That is, during the manufacturing process of the anode diffusion layer 308, the sensing element 320 is buried in the plurality of the graphite felts or carbon felts, such that the sensing element 320 can measure the current and voltage passing through the first electrode 302, but the instant disclosure is not limited herein. The sensing element 320 is not limited to sensing the current and voltage, but also can sense the temperature and/or pressure. In other words, the sensing element 320 can be a voltage sensor, current sensor, temperature sensor and/or pressure sensor.

In addition to the above features, in the embodiment, the insulating frame 322 is further disposed at the first electrode 302, so as to form the first electrode 302 that is a structure having the center section surrounded by the insulating frame 322. The center section is such as several layers of carbon felts. Due to the fuel cell generating water during the reaction process, the insulating frame 322 also can achieve the advantage of deceasing the short circuit problem generated by the first electrode 302 and other components of the fuel cell, so as to improve problems derived from the short circuit.

### Efficacy of Embodiments

According to the above embodiments in the instant disclosure, there are technical effects as follows:

1. Due to the ordinary flow battery and fuel cell both having sealing structure, the status inside the battery cannot be known when their manufacturing is completed. When the battery cannot normally supply the power, we are aware of the battery has been damaged, and it is really an inconvenience. In the embodiment of the instant disclosure, during the manufacturing process of the flow battery or fuel cell, the sensing element is produced in the electrode, and the battery is then sealed, such that the status inside the battery can be obtained depending on the data measured by the sensing element.

2. In an embodiment of the instant disclosure, the insulating frame is produced at the flow battery or the fuel cell, so as to insulate the pipeline passing through the electrode of the above batteries and the center section of the electrode. Therefore, the electrode of the battery is not liable to have a short circuit generated by the pipeline and other components of the battery, so as to overcome problems relating to the short circuit of the battery.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A cell module, comprising:
an ion exchange membrane;
a first electrode and a second electrode disposed at two sides of the ion exchange membrane, wherein a sensing element is disposed in the first electrode, and the first electrode includes an insulating frame;
a first current collector plate located at one side of the first electrode; and
a second current collector plate located at one side of the second electrode.

2. The cell module as claimed in claim 1, wherein the cell module is a flow battery module.

3. The cell module as claimed in claim 2, wherein the insulating frame defines an inlet aperture and an outlet aperture.

4. The cell module as claimed in claim 2, wherein the first electrode includes a center section, the center section is surrounded by the insulating frame, the center section is composed of several layers of carbon felts, and the sensing element is disposed in the carbon felts.

5. The cell module as claimed in claim 2, further comprising a first collector plate disposed between the first current collector plate and the first electrode, and a second collector plate disposed between the second current collector plate and the second electrode.

6. The cell module as claimed in claim 1, wherein the cell module is a fuel cell module.

7. The cell module as claimed in claim 6, wherein the first electrode includes an anode diffusion layer and an anode catalyst layer, and the sensing element is disposed in the anode diffusion layer.

8. The cell module as claimed in claim 7, wherein the anode diffusion layer is composed of the several layers of carbon felts, and the sensing element is disposed in the carbon felts.

9. The cell module as claimed in claim 1, wherein the sensing element is a flexible circuit substrate.

10. The cell module as claimed in claim 1, wherein the sensing element is a current sensor, voltage sensor, temperature sensor or pressure sensor.
